(19) United States
(12) Patent Application Publication
(10) Pub. No.: US 2022/0186790 A1
(43) Pub. Date: Jun. 16, 2022

(54) Arrangement with a Component for a Transmission of a Vehicle

(71) Applicant: ZF Friedrichshafen AG, Friedrichshafen (DE)

(72) Inventor: Markus Scherer, Deggenhausertal (DE)

(21) Appl. No.: 17/550,410

(22) Filed: Dec. 14, 2021

(30) Foreign Application Priority Data
Dec. 15, 2020 (DE) 10 2020 215 912.2

(51) Int. Cl. F16D 25/0635; F16D 13/74; F16D 13/64

(52) U.S. Cl. CPC F16D 25/0635; F16D 13/64; F16D 13/74

(57) ABSTRACT

An arrangement with at least one component (1) for a transmission of a vehicle is provided. The component (1) has an annular cylindrical interior (3) and is rotationally fixedly and axially movably connected to an input shaft (2). The component (1) has at least one passage bore (4) for hydraulic pressure balancing. The annular cylindrical interior (3) of the component (1) has at least one interior contour (5A, 5B) assigned to the passage bore (4) as an area reducing a stress concentration.

### CROSS-REFERENCE TO RELATED APPLICATION

The present application is related and has right of priority to German Patent Application No. 102020215912.2 filed in the German Patent Office on Dec. 15, 2020, which is incorporated by reference in its entirety for all purposes.

### FIELD OF THE INVENTION

The present invention generally concerns an arrangement with a component for a transmission of a vehicle. The invention furthermore generally concerns a transmission with the arrangement.

### BACKGROUND

In automotive technology, automatic transmissions are known in which several actuatable shift elements are provided in order to achieve translation ratios, via which elements a torque is transmitted from an input shaft to the output. The shift elements are actuated hydraulically. For this, inter alia, cylindrical components are required which are rotationally fixedly and axially movably connected to an input shaft of the automatic transmission. The components have passage bores for hydraulic pressure balancing.

It has been found that in the region of the passage bores, considerable mechanical loads occur on the components so that premature component failure may occur.

### SUMMARY OF THE INVENTION

Example aspects of the present invention provide an arrangement of the type described initially, and a transmission with the arrangement, in which premature component failure is prevented.

An arrangement is thus proposed with at least one component for a transmission of a vehicle, wherein the component has an annular cylindrical interior and is rotationally fixedly and axially movably connected to an input shaft. The component has at least one passage bore for hydraulic pressure balancing or oil conduction. In order to prevent premature component failure, the annular cylindrical interior of the component has at least one interior contour assigned to the passage bore as an area reducing stress concentration.

The modified design of the interior contour of the component creates a homogenous distribution of the mechanical forces occurring, so as to improve component strength. The proposed interior contour conducts the mechanical stresses past the passage bore and thus reduces the mechanical stresses and loads occurring. Because the strain tensors occurring run more homogenously along the passage bore, the component strength is significantly higher.

It is particularly advantageous if the interior contour of the component reducing the stress concentration is provided or runs at least between a shaft or outlet region of the passage bores and an internal diameter of the annular cylindrical interior of the component. The greatest mechanical loads occur in this region, so it is particularly advantageous to change the stress development in this area accordingly so that no stress peaks can occur in this region. This considerably extends the component service life.

In principle, it is possible to achieve the interior contour reducing the stress concentration in various structural ways. For example, the interior contour reducing the stress concentration may form a constant polynomial line as a curve, viewed in longitudinal section. Here, the interior contour is achieved by several polynomial function curves provided one after the other, wherein the respective transitions between the polynomial function curves are constant, i.e., formed in a predefined radius, and have no non-constant jumps in the curve.

Another way of designing the interior contour reducing the stress concentration may for example be to implement a constant radius as a curve, viewed in longitudinal section. Irrespective of the actually selected course of the interior contour, in any case a particular homogenous mechanical stress distribution is achieved with improved component strength.

The annular cylindrical interior is particularly suitable if the component is arranged coaxially to the input shaft. In this design, the internal diameter of the annular cylindrical interior corresponds to an external diameter of a sleeve region for attaching the component to the input shaft. Accordingly, the interior is arranged radially on the outside of the component, while the sleeve region of the component is arranged on the radial inside and receives the input shaft. In this way, a particularly compact arrangement is achieved since a radially nested structure is possible.

A further example aspect of the invention claims a transmission with the arrangement as described above, so that the advantages already described and further advantages are achieved. As a transmission, preferably an eight-speed automatic transmission may be provided. Particularly advantageously, the component is designed as an inner plate carrier of a shift element configured as a friction clutch.

### BRIEF DESCRIPTION OF THE DRAWINGS

Example aspects of the invention are described in more detail below with reference to the drawings. The drawings shows:

FIG. 1 a schematic, longitudinal section through an eight-speed automatic transmission with an arrangement according to example aspects of the invention, with a component as an inner plate carrier of one of the friction clutches of the automatic transmission;

FIG. 2 a schematic, three-dimensional, individual view of the example component;

FIG. 3 a schematic, longitudinal section through the component according to a first example embodiment variant of an interior contour as a polynomial line curve;

FIG. 4 a schematic cross-section of the interior contour of the component from FIG. 3;

FIG. 5 a schematic three-dimensional detail view of the interior contour from FIGS. 3 and 4;

FIG. 6 a schematic, longitudinal section through the component according to a second example embodiment variant of an interior contour with a constant radius;

FIG. 7 a schematic cross-section of the interior contour of the component from FIG. 6; and

FIG. 8 a schematic, three-dimensional detail view of the interior contour from FIGS. 6 and 7.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

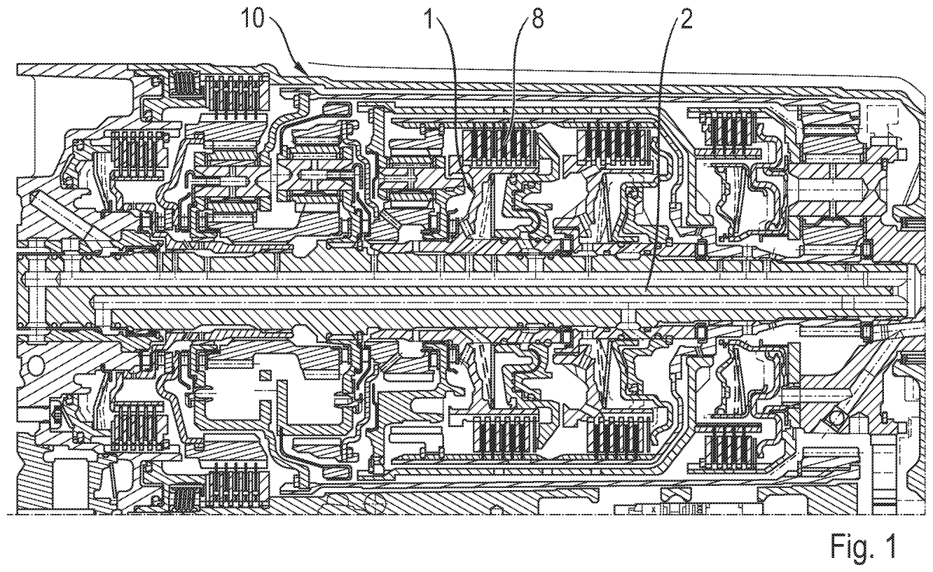

FIGS. 1 to 8 show as examples various views of an arrangement according to example aspects of the invention with a component or cylinder component 1 for a transmission of a vehicle. The arrangement according to example aspects of the invention with the component 1 is shown, purely as an example, with reference to an eight-speed automatic transmission 10 for actuation of a shift element configured as a friction clutch 8.

FIG. 1 shows as an example a longitudinal section through the eight-speed automatic transmission 10, in which the component 1 of the arrangement according to example aspects of the invention forms an inner plate carrier of a specific friction clutch 8, wherein further transmission components of the automatic transmission 10 are illustrated.

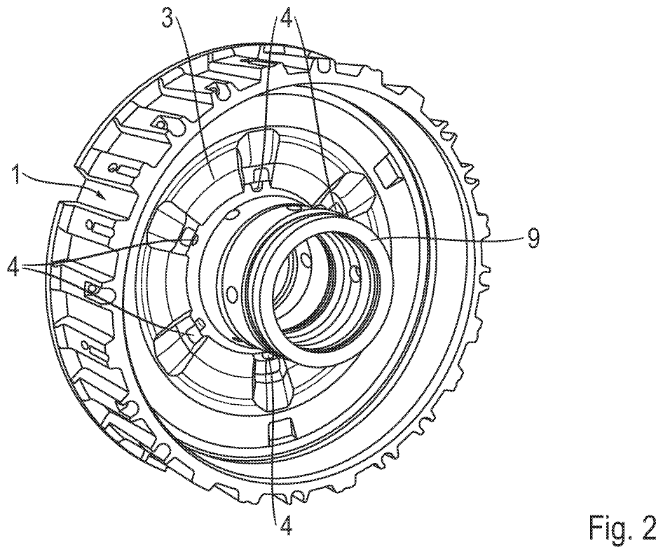

The component 1 of the arrangement according to example aspects of the invention is rotationally fixedly and axially movably connected to an input shaft 2. For actuation of the friction clutch 8, the component 1 has an annular cylindrical interior 3 in which a hydraulically actuated piston is movable. Several passage bores 4 are provided on the component 1 for hydraulic pressure balancing, as evident for example from FIG. 2.

In order to achieve a significantly greater component strength, it is provided that the annular cylindrical interior 3 of the component 1 has at least one interior contour 5A, 5B assigned to the passage bore 4 as an area reducing stress concentration.

Irrespective of the example design variants, with the arrangement according to example aspects of the invention, it is provided that the component 1 is arranged coaxially to the input shaft 2, and an internal diameter 7 of the annular cylindrical interior 3 forms an external diameter of the sleeve region 9 for attaching the component 1 to the input shaft 2. Accordingly, the input shaft 2 is arranged inside the sleeve region 9, while the cylindrical interior 3 of the component 1 extends radially on the outside around the sleeve region 9. The interior contour 5A, 5B of the component 1 reducing the stress concentration runs at least between a shaft or outlet region 11 of the passage bore 4 and the internal diameter 7 of the annular cylindrical interior 3.

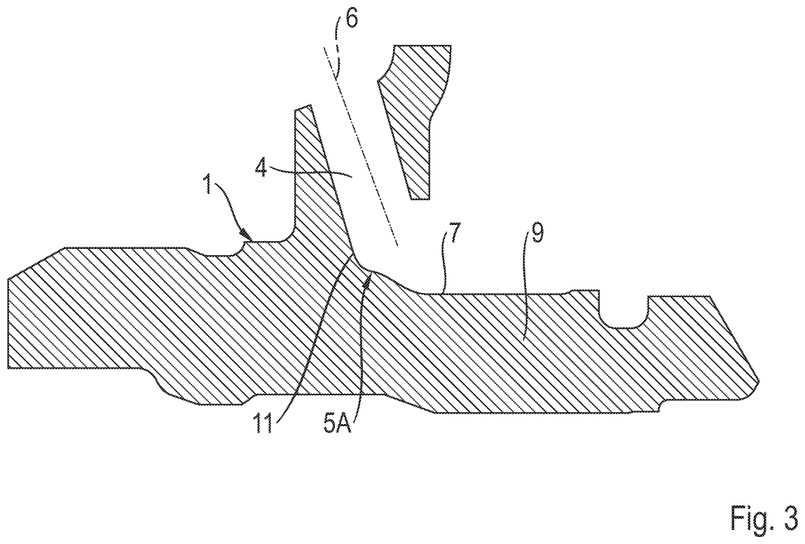

FIGS. 3, 4 and 5 show as an example a first possible example embodiment variant of the interior contour 5A. In the first example design variant, the course of the interior contour 5A reducing the stress concentration, viewed in longitudinal section, is configured as a constant polynomial line curve, as evident from FIG. 3. The polynomial curve consists of several polynomial function curves provided one after the other, each with constant transition region.

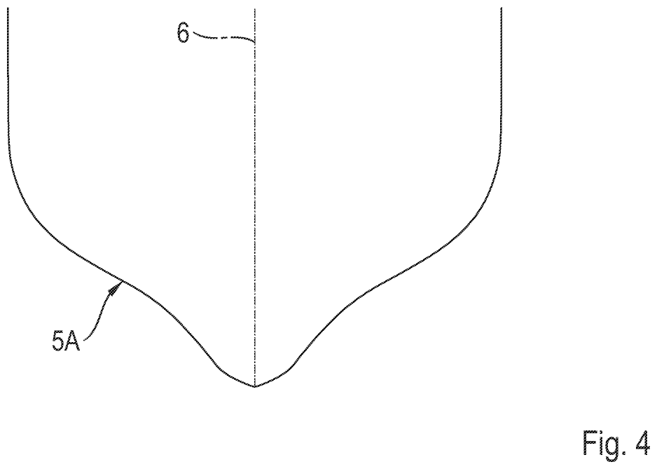

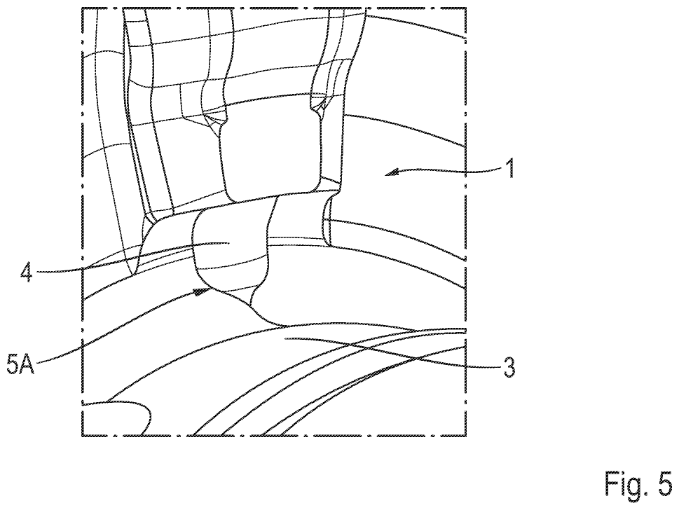

FIG. 4 shows a cross-section through the interior contour 5A shown spatially in FIG. 5. Again, a polynomial line is formed in cross-section which is designed symmetrically to the longitudinal axis 6 of the passage bore 4. This cross-sectional form is also evident in FIG. 5.

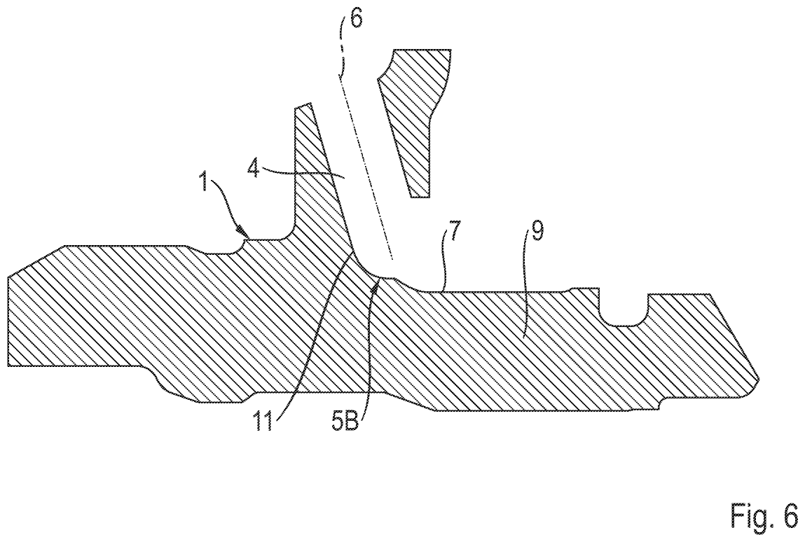

FIGS. 6, 7 and 8 show as an example a second possible example design variant of the interior contour 5B. In the second example design variant, the course of the interior contour 5B reducing the stress concentration, viewed in longitudinal section, is a constant radius, as evident from FIG. 6.

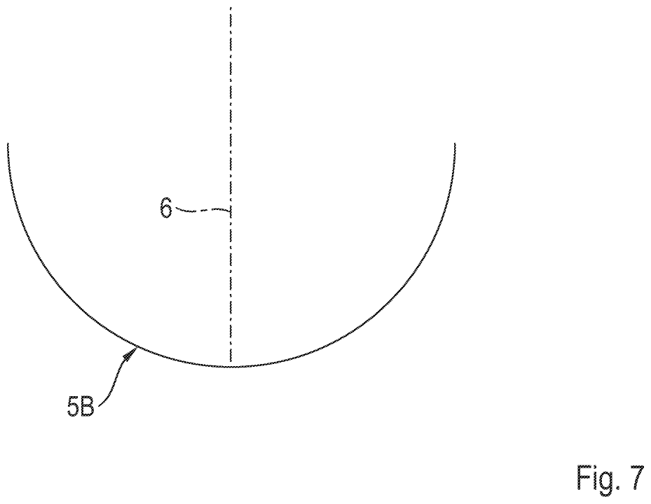

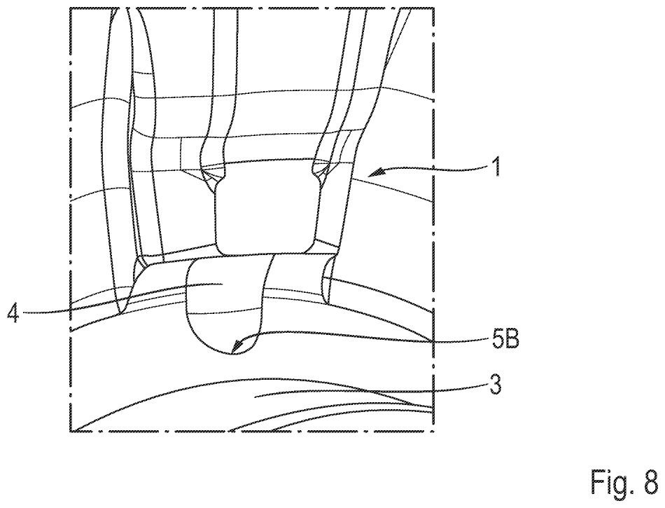

FIG. 7 shows a cross-section through the interior contour 5 illustrated spatially in FIG. 8. Again, a constant radius is formed in cross-section which is designed symmetrically to the longitudinal axis 6 of the passage bore 4. This cross-sectional form is also evident in FIG. 8.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE SIGNS

1 Component or cylinder component
2 Input shaft
3 Annular cylindrical interior
4 Passage bore
5A Interior contour as polynomial line
5B Interior contour as constant radius
6 Longitudinal axis of passage bore
7 Internal diameter of annular cylindrical interior, or external diameter of sleeve region
8 Friction clutch
9 Sleeve region
10 Eight-speed automatic transmission
11 Shaft or outlet region of passage bore

1-9. (canceled)

10. An arrangement for a transmission of a vehicle, comprising:
an input shaft (2);
at least one component (1) having an annular cylindrical interior (3), the component (1) rotationally fixedly and axially movably connected to the input shaft (2), the component (1) defining at least one passage bore (4) for hydraulic pressure balancing, wherein the annular cylindrical interior (3) of the component (1) has at least one interior contour (5A, 5B) for the passage bore (4) that is configured as an area reducing a stress concentration.

11. The arrangement of claim 10, wherein the interior contour (5A, 5B) of the component (1) reducing the stress concentration is disposed at least between a shaft (11) of the passage bore (4) and an internal diameter (7) of the annular cylindrical interior (3).

12. The arrangement of claim 10, wherein the interior contour (5A) reducing the stress concentration forms a constant polynomial line as a curve when viewed in a longitudinal section.

13. The arrangement of claim 10, wherein the interior contour (5B) reducing the stress concentration forms a constant radius as a curve when viewed in a longitudinal section.

14. The arrangement of claim 10, wherein the annular cylindrical interior (3) defines a plurality of passage bores (4) distributed over a circumference of the annular cylindrical interior (3), and a respective interior contour (5A, 5B) reducing stress concentration is provided for each of the passage bores (4).

15. The arrangement of claim 10, wherein the component (1) is arranged coaxially to the input shaft (2), and an internal diameter (7) of the annular cylindrical interior (3) forms an external diameter of a sleeve region (9) for attaching the component (1) to the input shaft (2).

16. A transmission, comprising the arrangement of claim 10.

17. The transmission of claim 16, wherein the component (1) is configured as an inner plate carrier of a friction clutch (8).

18. The transmission of claim 16, wherein the transmission is configured as an eight-speed automatic transmission (10).
